(19) United States
(12) Patent Application Publication
(10) Pub. No.: US 2025/0278295 A1
(43) Pub. Date: Sep. 4, 2025

(54) POLICY ADAPTATION BASED ON IMPORTANCE SAMPLING

(71) Applicant: Samsung Display Co., Ltd., Yongin-si (KR)

(72) Inventors: Shuhui Qu, Fremont, CA (US); Janghwan Lee, Pleasanton, CA (US)

(21) Appl. No.: 18/629,600

(22) Filed: Apr. 8, 2024

Related U.S. Application Data
(60) Provisional application No. 63/560,287, filed on Mar. 1, 2024.

(51) Int. Cl. G06F 9/48

(52) U.S. Cl. CPC G06F 9/4881; G06F 9/485

(57) ABSTRACT

A system and a method are disclosed for scheduling, the method includes determining a second state distribution based on executing a first scheduling policy in a second environment, generating a second scheduling policy based on a first policy gradient associated with a first state distribution and the second state distribution, the first state distribution being associated with the first scheduling policy and a first environment, different from the second environment, and controlling a scheduling process based on the second scheduling policy.

### CROSS-REFERENCE TO RELATED APPLICATION

This application claims the priority benefit under 35 U.S.C. § 119(e) of U.S. Provisional Application No. 63/560,287, filed on Mar. 1, 2024, the disclosure of which is incorporated by reference in its entirety as if fully set forth herein.

### TECHNICAL FIELD

The disclosure generally relates to manufacturing systems and methods. More particularly, the subject matter disclosed herein relates to improvements to scheduling by performing policy adaptation based on importance sampling.

### SUMMARY

Manufacturing facilities may face the challenge of efficiently producing a diverse range of products. For example, a number of product lots (e.g., product types) may be in a range of hundreds of thousands. Each product lot may undergo numerous processes across multiple machines. Efficient coordination of the machines, products, resources, and/or the like of a manufacturing system is important for achieving higher productivity and utilization. Experts with extensive domain expertise and years of training may be able to produce reasonable manufacturing scheduling policies. However, adapting existing scheduling policies to changing scenarios and changing evaluation criteria (e.g., evaluation metrics) based on human experience and expertise alone may be inadequate for achieving satisfactory results. As used herein, a “scenario” refers to a configuration (e.g., a status) of an environment (e.g., a manufacturing environment), which may be represented by a variety of parameters associated with the environment and collected in a dataset. Some examples of scenarios include states of products, resources, and/or machines and logistics associated with the products, resources, and/or machines.

Reinforcement learning (RL) may be used to help determine improved scheduling. For example, a scheduling policy may be trained in a training environment on a simulator (e.g., a digital simulator) using a historic dataset to develop (e.g., to train) the scheduling policy for use in controlling a scheduling process. The historic dataset may include gaps in scenario coverage when the trained scheduling policy is deployed. For example, the historic dataset may have been collected over an incomplete time period (e.g., only part of a year), or various parameters may have changed since the data for the historic dataset was collected.

Misalignment between training data and deployment scenarios may reduce (e.g., may significantly reduce) system performance. For example, trainings may not be effective for achieving satisfactory performance when a distribution in a state visitation (e.g., a steady-state distribution) in a training environment is not similar to (e.g., not sufficiently similar to) a distribution in the state visitation (e.g., a steady-state distribution) in a deployment environment. As used herein, a “state distribution” refers to a probability that a given state will be visited or will occur in reinforcement learning.

It may be suitable for systems to be able to perform policy adaptation using computers with limited computational power. For example, industrial computers used in deployment may include general purpose processors (e.g., central processing units (CPUs)) that are less capable than specialized processors (e.g., graphics processing units (GPUs)) at performing training (e.g., complex training). Strict deployment time limits (e.g., short deployment time limits) may further restrict training and adaptation. For example, a scheduling policy may need to be deployed and updated within a matter of minutes (e.g., several minutes).

In some embodiments of the present disclosure, policy adaptation may include designing a new scheduling policy based on analyzing backtest cases to achieve improved performance. As used herein, a “backtest case” refers to testing a machine learning (ML) model (e.g., a scheduling policy) that has been trained on historic data and evaluating the performance and/or effectiveness of the model in a deployment environment.

Aspects of some embodiments of the present disclosure provide for efficient policy adaptation, which may be implemented using limited computational resources. For example, a production line having limited computational resources (e.g., using industrial computers) may be enabled to determine an improved scheduling policy based on limited processing capabilities and within a restricted time frame.

According to some embodiments of the present disclosure, a method for scheduling includes determining a second state distribution based on executing a first scheduling policy in a second environment, generating a second scheduling policy based on a first policy gradient associated with a first state distribution and the second state distribution, the first state distribution being associated with the first scheduling policy and a first environment, different from the second environment, and controlling a scheduling process based on the second scheduling policy.

The method may further include determining the first state distribution based on executing the first scheduling policy in the first environment.

The first environment may include a training environment in which the first scheduling policy is trained.

The first scheduling policy may be trained based on historic data.

The second environment may include a deployment environment, and the first scheduling policy may be tested in the deployment environment based on present data that differs from the historic data based on at least one parameter.

The method may further include determining a first performance associated with executing the first scheduling policy in the second environment, and determining to perform the controlling of the scheduling process based on the second scheduling policy based on comparing a second performance, associated with executing the second scheduling policy in the second environment, with the first performance.

The method may further include determining to perform the controlling of the scheduling process based on the second scheduling policy based on determining that a current time value is greater than or equal to a threshold time value.

The method may further include, based on executing the first scheduling policy in the second environment, determining a trajectory associated with the first scheduling policy.

The controlling the scheduling process based on the second scheduling policy may include one of changing an order of machine operations, selecting different navigation tasks, or changing an order of language model tasks.

The method may further include determining that a current time value is less than a threshold time value, determining a third state distribution associated with the second scheduling policy, and generating a third scheduling policy based on a second policy gradient associated with the second state distribution and the third state distribution.

According to some other embodiments of the present disclosure, a system for scheduling includes a processing circuit communicatively coupled to a machine, the processing circuit configured to perform determining a second state distribution based on executing a first scheduling policy in a second environment, generating a second scheduling policy based on a first policy gradient associated with a first state distribution and the second state distribution, the first state distribution being associated with the first scheduling policy and a first environment, different from the second environment, and controlling a scheduling process based on the second scheduling policy.

The processing circuit may be configured to perform determining the first state distribution based on executing the first scheduling policy in the first environment.

The first environment may include a training environment in which the first scheduling policy is trained.

The first scheduling policy may be trained based on historic data.

The second environment may include a deployment environment, and the first scheduling policy may be tested in the second environment based on updated data that differs from the historic data based on at least one parameter.

According to some other embodiments of the present disclosure, a system for scheduling includes a processing circuit and memory including instructions that, when executed by the processing circuit, cause the processing circuit to perform determining a second state distribution based on executing a first scheduling policy in a second environment, generating a second scheduling policy based on a first policy gradient associated with a first state distribution and the second state distribution, the first state distribution being associated with the first scheduling policy and a first environment, different from the second environment, and controlling a scheduling process based on the second scheduling policy.

The instructions, when executed by the processing circuit, may cause the processing circuit to perform determining the first state distribution based on executing the first scheduling policy in the first environment.

The first environment may include a training environment in which the first scheduling policy is trained.

The first scheduling policy may be trained based on historic data.

The second environment may include a deployment environment, and the first scheduling policy may be tested in the second environment based on updated data that differs from the historic data based on at least one parameter.

The above approaches improve on previous methods because they allow for efficient determination of improved scheduling policies that may be adapted to changing scenarios and evaluation metrics. For example, determining an improved scheduling policy, which previously took about 100 hours (e.g., based on trial-and-error alone) may take minutes or less based on aspects of some embodiments of the present disclosure.

### BRIEF DESCRIPTION OF THE DRAWING

In the following section, the aspects of the subject matter disclosed herein will be described with reference to exemplary embodiments illustrated in the figures.

FIG. 1A is a system diagram depicting a system for manufacturing scheduling, according to some embodiments of the present disclosure.

FIG. 1B is a block diagram depicting a method for determining a new scheduling policy, according to some embodiments of the present disclosure.

FIG. 2 is a block diagram depicting an RL decision process associated with determining new scheduling policies, according to some embodiments of the present disclosure.

FIG. 3 is a flowchart depicting example operations of a method for scheduling, according to some embodiments of the present disclosure.

FIG. 4 is a block diagram of an electronic device in a network environment, according to some embodiments of the present disclosure.

FIG. 5 is a flowchart of a method of executing a schedule (e.g., a scheduling policy), according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “or” and “and/or” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

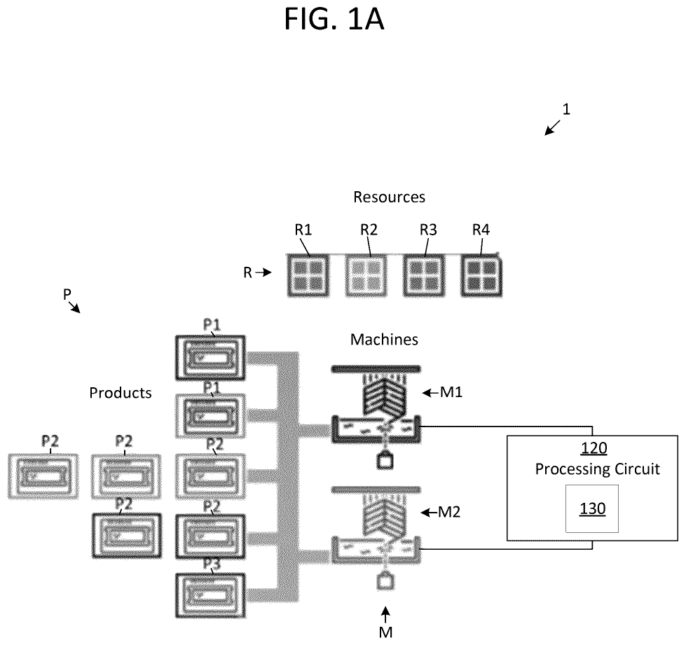

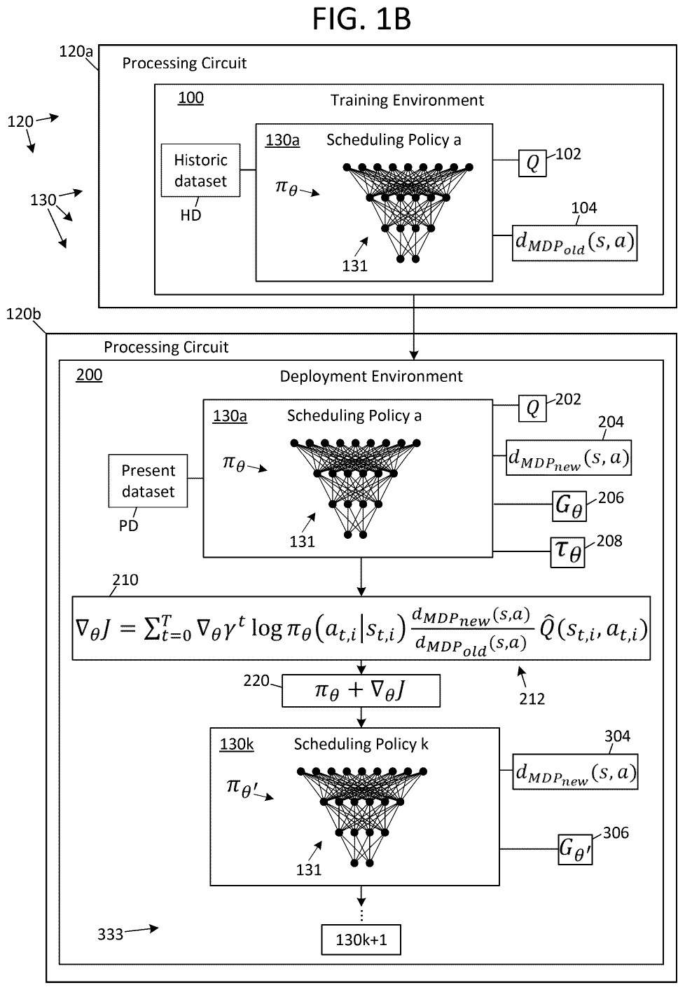

FIG. 1A is a system diagram depicting a system for manufacturing scheduling, according to some embodiments of the present disclosure.

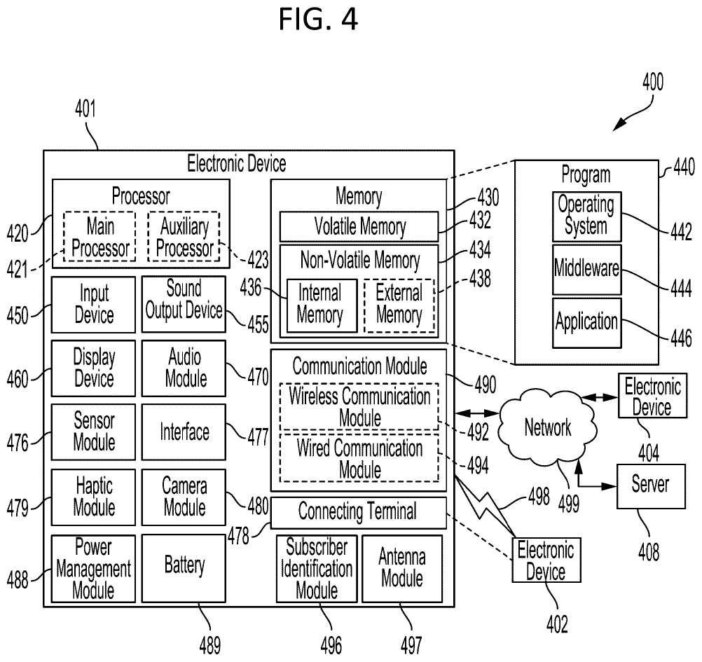

Referring to FIG. 1A, a system 1 (e.g., a manufacturing system) may include a processing circuit 120 (e.g., a processing circuit of the manufacturing system) for determining, updating, and/or implementing scheduling policies 130. As used herein, a “scheduling policy” refers to any model that receives information about jobs and/or machines for processing the jobs and that outputs a job to be processed (e.g., outputs a rank of jobs to be processed). For example, a job having the highest rank may be processed by an available machine. An example of a scheduling policy is a machine learning (ML) model. For example, each scheduling policy 130 may include an ML model. The ML model may be any ML model known to one of ordinary skill in the art. In some embodiments, the ML model may include a neural network 131 (see FIG. 1B). In some embodiments, the ML model may include a linear model. As used herein “training” a scheduling policy refers to adjusting parameters (e.g., weights) of the ML model. The processing circuit 120 may correspond to the processor 420 of FIG. 4. The system 1 may include machines M (e.g., manufacturing devices, including robots and/or the like), products P (e.g., jobs), and resources R. In some embodiments, the processing circuit 120 may be communicatively coupled to the machines M to implement the scheduling policies 130 and/or to observe results (e.g., performance results) associated with the scheduling policies 130. For example, the system 1 may include a first machine M1 and a second machine M2. The machines M may utilize the resources R to produce the products P. The products may include, for example, different types of display devices or different types of integrated circuits (ICs). The products may include a first type of product P1, a second type of product P2, and a third type of product P3. The resources R may include, for example, a mask (e.g., a semiconductor photomask) and/or materials for producing the products P. Although FIG. 1A depicts only a few machines, products, and resources, it should be understood that many (e.g., thousands of) machines and processes may be used per product in a typical manufacturing system.

The performance of the system 1 may be determined based on one or more performance criteria (e.g., performance metrics). For example, performance metrics may include targets (e.g., goals) for production capacity (e.g., a number of products produced per day), efficiency (e.g., power consumption, minimized downtime, etc.), time (e.g., on-time delivery), and/or the like. As discussed above, a scheduling policy 130 may be trained in a training environment using a historic dataset. When tested in a deployment environment, the scheduling policy 130 may have different performance results from the training environment. For example, present data associated with present manufacturing scenarios may have changed from the historic data associated with previous manufacturing scenarios.

Aspects of some embodiments of the present disclosure allow the system 1 to improve (e.g., to optimize) scheduling policy performance in real time, with limited computational resources, within a short time frame, and without extensive tuning.

FIG. 1B is a block diagram depicting a method for determining a new scheduling policy, according to some embodiments of the present disclosure.

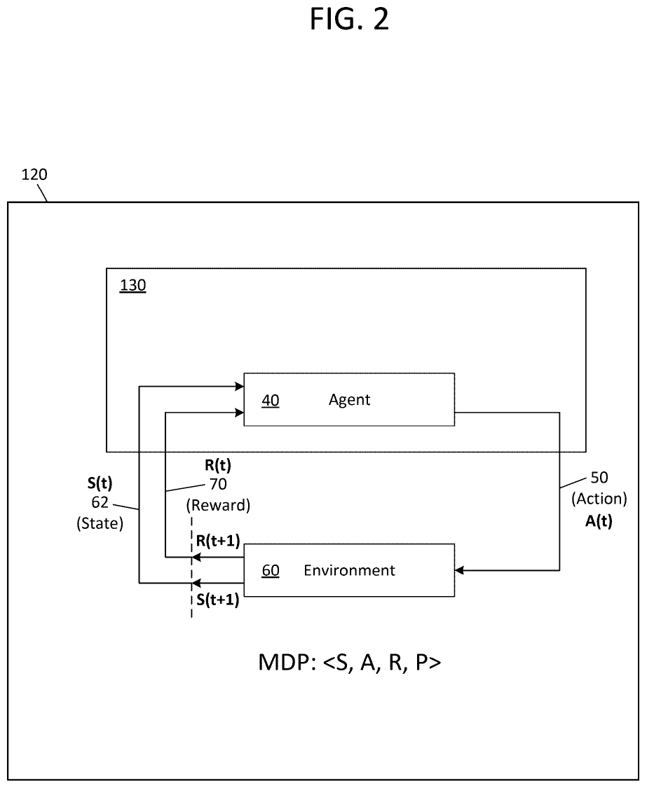

Referring to FIG. 1B, aspects of embodiments of the present disclosure allow for efficient adaptation of scheduling policies 130. In some embodiments, one or more of the scheduling policies 130 may include an ML model. For example, the ML model may include a neural network 131. Although the present disclosure depicts neural networks 131, one or more of the scheduling policies 130 may include any suitable model known to one of ordinary skill in the art. For example, one or more of the scheduling policies 130 may include a linear model, a regression model (e.g., a neural network, a tree model, etc.), and/or the like. One or more processing circuits 120 may perform methods for generating a second scheduling policy 130k (e.g., a k-th scheduling policy) based on updating a first scheduling policy 130a (e.g., a previous scheduling policy). In some embodiments, the first scheduling policy 130a, which may also be referred to mathematically as π_{θ}, may be trained in a first environment 100 (e.g., a “training environment”). The first environment 100 may train the first scheduling policy 130a with a historic dataset HD including historic data. The historic dataset HD may include data corresponding to various parameters associated with scenarios (e.g., previously observed scenarios) of the system 1 (see FIG. 1A). In some embodiments, the first scheduling policy 130a may be executed in the first environment 100. In some embodiments, the first scheduling policy 130a may be trained with a first processing circuit 120a. The first processing circuit 120a may have specialized processing resources. For example, the first processing circuit 120a may include processing resources (e.g., one or more GPUs) that are suitable for artificial intelligence (AI) related processing. In some embodiments, a first Q-value 102 and/or a first state distribution 104 (e.g., a first steady-state distribution) may be obtained (e.g., determined) based on executing the first scheduling policy 130a in the first environment 100. For example, the Q-value 102 may be obtained through training an RL agent (see FIG. 2) in a training Markov decision process (MDP), while the first state distribution 104 may be obtained by counting a number of visitance (e.g., a number of visits) of a state through executing the first scheduling policy 130. The first state distribution 104 may be represented mathematically as d_{MDP}_{_{old}}(s, a).

In some embodiments, the one or more processing circuits 120 may execute the first scheduling policy 130a in a second environment 200 (e.g., a “deployment environment” or “testing environment”). The deployment environment 200 may test the first scheduling policy 130a based on a present dataset PD including present data. The present dataset PD may include data corresponding to various parameters associated with scenarios (e.g., presently observed scenarios) of the system 1 (see FIG. 1A). Due to changing circumstances, the present dataset PD may differ from the historic dataset HD based on (e.g., with respect to) one or more parameters. For example, a parameter of the historic dataset HD may indicate that a first product P1 (see FIG. 1A) has an arrival frequency of 10 pieces per week, while the present dataset PD indicates that the first product P1 has an arrival frequency of 50 pieces per week. Accordingly, the first scheduling policy 130a may perform differently in the first environment 100 from how the first scheduling policy 130a performs in the second environment 200. In some embodiments, the first scheduling policy 130a may be tested with a second processing circuit 120b. The second processing circuit 120b may have more limited processing resources (e.g., more limited computational resources) than the specialized processing resources of the first processing circuit 120a. For example, the second processing circuit 120b may include general-purpose processing resources (e.g., one or more CPUs) that are less suitable for AI-related processing than the specialized processing resources of the first processing circuit 120a. In some embodiments, a second Q-value 202 and/or a second state distribution 204 (e.g., a second steady-state distribution) may be obtained (e.g., determined) based on executing the first scheduling policy 130a in the second environment 200. The second state distribution 204 may be represented mathematically as d_{MDP}_{_{new}}(s, a). A first performance 206, which may be represented mathematically as G_{θ}, and a first trajectory 208, which may be represented mathematically as τ_{θ}, may be obtained (e.g., determined) based on executing the first scheduling policy 130a in the second environment 200.

In some embodiments, the second scheduling policy 130k, which may be represented mathematically as π_{θ′}, may be determined based on calculating a first policy gradient 210, which may be associated with a state distribution difference, and which may be represented mathematically as ∇_{θ}J. The first policy gradient 210 may be associated with the first state distribution 104 and the second state distribution 204. In other words, the first policy gradient 210 may be calculated based a ratio of the second state distribution 204 and the first state distribution 104. Determining the ratio of the second state distribution 204 and the first state distribution 104 may be referred to as “importance sampling” because the ratio of the second state distribution 204 and the first state distribution provides a way to determine (e.g., to calculate) an impact of the second state distribution 204 on a parameter (or parameters) being estimated. For example, the importance sampling involves changing a probability density function to generate more events (e.g., more rare events) that have more of an impact on the parameter (or parameters) being estimated. A state that is visited more frequently (e.g., a state that has a greater state distribution) may have a greater impact on the parameter (or parameters) being estimated.

In some embodiments, the second scheduling policy 130k may be determined based on an update function 220. The update function 220 may update the first scheduling policy 130a with the first policy gradient 210. For example, the second scheduling policy 130k may correspond to the sum of the first scheduling policy 130a and the first policy gradient 210. The Q value 202 and the trajectory 208 may also be used to calculate the first policy gradient 210, as discussed below in relation to, for example, equation 0.4 to equation 0.7.

In some embodiments, the second scheduling policy 130k may be executed in the second environment 200. A second performance 306, which may be represented mathematically as G_{θ′}, may be determined based on executing the second scheduling policy 130k in the second environment 200. In some embodiments, the second scheduling policy 130k may be selected to control a scheduling process, associated with the system 1 (see FIG. 1A), based on comparing the second performance 306 with the first performance 206. For example, if the second performance 306 sufficiently improves the scheduling process (e.g., satisfies a given set of evaluation metrics), the second scheduling policy 130k may be selected to control the scheduling process.

In some embodiments, the second scheduling policy 130k or a third scheduling policy 130k+1 (e.g., a k+1-th scheduling policy) may be selected to control the scheduling process based on determining whether a current time value is greater than or equal to a threshold time value. For example, in some embodiments, the second processing circuit 120b may determine a scheduling policy for controlling the scheduling process based on an iterative process 333. For example, as part of the iterative process 333, the second processing circuit 120b may determine that the current time value is less than the threshold time value and may execute the second scheduling policy 130k in the second environment 200 to determine a third state distribution 304. The second processing circuit 120b may generate the third scheduling policy 130k+1 based determining a second policy gradient associated with the second state distribution 204 and the third state distribution 304. In other words, the scheduling policy may be updated iteratively based on determining whether more time remains to perform updating.

A process flow of the method for scheduling may include one or more of the following operations. A test policy may include the equation 1.0*(waiting time)+0.0001*(queue length). That is, the test policy μ may be trained to have a weight of 1.0 assigned to a waiting time (e.g., a waiting time for different products P in respective queues) and to have a weight of 0.0001 assigned to a queue length (e.g., a queue length of each of the products P in their respective queues). The processing circuit 120 may obtain a state distribution d_{MDP}_{_{old}}(s, a) of the test policy μ from its training environment. The processing circuit 120 may obtain a state distribution d_{MDP}_{_{new}}(s, a) and a corresponding schedule performance G₁ of the test policy μ in a deployment environment. The processing circuit 120 may calculate a policy gradient of the test policy μ in the deployment environment. The processing circuit 120 may update the test policy μ, such that an updated test policy μ′ includes the equation 0.8*(waiting time)+0.15*(queue length). That is, the weights respectively assigned to the waiting time and queue length may be changed based on the policy gradient. The processing circuit 120 may obtain the state distribution of d_{MDP}_{_{new,μ′}}(s, a) with μ′ and the corresponding schedule performance G₂. The processing circuit 120 may output the better of the two schedules μ and μ′.

While embodiments of the present disclosure are described herein in the context of generating scheduling policies for coordinating various manufacturing processes and the like for the system 1, the present disclosure is not limited thereto. For example, the systems and methods described herein may be applicable to any suitable systems and methods that may benefit from generating a new policy to achieve satisfactory results. In other words, as long as there is a policy that takes in some parameters/factors and outputs a decision/action, it can be used to generate a new policy according to one or more embodiments of the present disclosure. For example, the systems and methods described in more detail herein may be applicable to various robotic control applications, navigation systems, autonomous driving applications, large language model training, and the like.

FIG. 2 is a block diagram depicting an RL decision process associated with determining new scheduling policies, according to some embodiments of the present disclosure.

Referring to FIG. 2, the processing circuit 120 may be configured to train scheduling policies 130 based on reinforcement learning. As used herein, “reinforcement learning” (RL) refers to a machine-learning technique, wherein an agent 40 (e.g., a machine-learning model) takes an action 50 (e.g., makes an update to one or more weights associated with the machine-learning model) in an environment 60 to improve or maximize a reward 70. The action 50 may change a state 62 associated with the environment 60 to improve or increase the reward 70 achieved with respect to the state 62 (e.g., a previous state) of the system in association with the environment 60. Based on RL, the processing circuit 120 may discover the actions 50 that maximize the reward 70 associated with any given state 62.

RL for improving scheduling policies 130 may be modeled as a MDP denoted as <S, A, R, P>, wherein an output scheduling policy 130 (or π) may be determined based on: a set of states 62 (e.g., environment-and-agent states S), a set of actions 50 (e.g., actions A of the agent 40), a probability P of transitioning from a first state s to a second state s′ under a given action a; and an immediate reward Rₐ(s, s′) after transitioning from the first state s to the second state s′ under the given action a.

The following discussion provides mathematical notation corresponding to the disclosure above related to FIGS. 1B and 2.

An RL objective, which may be to achieve an optimized policy, may be represented mathematically as:

$${max}_{π} {\sum }_{t = 0}^{T} {E}_{{s}_{t} ∼ {d}^{π} ( s ) , {a}_{t} ∼ π ( a \vert s )} [ {γ}^{t} r ( {s}_{t} , {a}_{t} ) ] \qquad ( equation 0.1 )$$

wherein d^{π}(s) refers to a steady-state distribution of states s, wherein sₜ˜d^{π}(s) refers to a steady-state distribution of the states, wherein π(a|s) refers to an optimal scheduling policy, wherein γ^{t} refers to a discount factor, and wherein [γ^{t}r(sₜ, aₜ)] refers to a cumulative discounted reward. The cumulative discounted reward [γ^{t}r(sₜ, aₜ)] may be obtained given the steady-state distribution of the states sₜ˜d^{π}(s) and the optimal scheduling policy π(a|s).

During training, the optimal scheduling policy π(a|s) may be determined for the training environment based on achieving the steady-state distribution of d^{π}(s). However, during a deployment in a deployment environment an expectation associated with the determined optimal scheduling policy may no longer hold due to a distribution drift. The distribution drift may occur due to changing scenarios that differ from training data. For example, the deployment environment may include different types of orders (e.g., different types of product orders) than the types of orders associated with the training data.

In some embodiments, a higher performance on the deployment case (e.g., in the deployment environment) with limited computational resources and time may be achieved by maximizing a summation of the cumulative discounted reward [γ^{t}r(sₜ, aₜ)] based on the deployment environment, which may be represented mathematically as:

$$\sum {γ}^{t} r ( {s}_{t} , {a}_{t} ) ∼ 〈 {S}^{′} , A , R , {P}^{′} , {s}_{0} 〉 \qquad ( equation 0.2 )$$

That is, the deployment environment <S′, A, R, P′> may differ from the training environment based on S′and P′. In some embodiments, the training environment (e.g., the old MDP environment may have a continuous arrival of jobs, while the jobs for the deployment environment (e.g., the new MDP environment) may be known in advance.

A policy gradient method may be utilized to determine an optimized policy in the deployment environment. In some embodiments, a policy gradient target may be determined based on:

$${J}_{θ} = {E}_{τ ∼ {π}_{θ}} [ {\sum }_{t = 0}^{T} {γ}^{t} r ( {s}_{t} , {a}_{t} ) ] \\ and \qquad ( equation 0.3 )$$

$${∇}_{θ} J = \frac{1}{N} {\sum }_{i = 0}^{N} {\sum }_{t = 0}^{T} {∇}_{θ} {γ}^{t} log {π}_{θ} ( {a}_{t , i} \vert {s}_{t , i} ) \hat{Q} ( {s}_{t , i} , {a}_{t , i} ) \qquad ( equation 0.4 )$$

wherein J_{θ} refers to a reward (e.g., a final reward), wherein E_{τ˜π}_{_{θ}}[Σₜ₌₀^{T}γ^{t}r(sₜ, aₜ)] refers to an expected summation of rewards (e.g., immediate rewards), ∇_{θ}J refers to the policy gradient, N refers to a number of rollouts (e.g., a number of training times), logπ_{θ}(a_{t,i}|s_{t,i}) refers to an expectation value of a log of the policy, and \hat{Q}(s_{t,i}, a_{t,i}) refers to a Q value of the state and action pair.

In deployment environments having short time limits, the environment may be considered static (e.g., not changing) and the number of rollouts N may, thus, be equal to one. Accordingly, the gradient may be determined mathematically based on:

$${∇}_{θ} J = {\sum }_{t = 0}^{T} {∇}_{θ} {γ}^{t} log {π}_{θ} ( {a}_{t} \vert {s}_{t} ) \hat{Q} ( {s}_{t} , {a}_{t} ) \qquad ( equation 0.5 )$$

In some embodiments, a modified version of equation 0.4 above for determining the policy gradient target may be represented mathematically as (equation 0.6):

$${∇}_{θ} J = \frac{1}{N} {\sum }_{i = 0}^{N} \frac{{π}_{θ} ( {τ}_{i} ∼ {MDP}_{new} )}{{π}_{θ} ( {τ}_{i} ∼ {MDP}_{old} )} {\sum }_{t = 0}^{T} {∇}_{θ} {γ}^{t} log {π}_{θ} ( {a}_{t , i} \vert {s}_{t , i} ) \hat{Q} ( {s}_{t , i} , {a}_{t , i} )$$

In some embodiments, a computational cost (e.g., an exponential computational cost) associated with determining:

$${π}_{θ} ( {τ}_{i} ∼ M D {P}_{new} ) {π}_{θ} ( {τ}_{i} ∼ M D {P}_{old} ) \qquad ( equation 0.7 )$$

may be reduced (e.g., minimized) by estimating the ratio of the state distribution of the new MDP environment (e.g., the deployment environment) and the state distribution of the old MDP environment (e.g., the training environment):

$$\frac{{d}_{{MDP}_{new}} ( s , a )}{{d}_{{MDP}_{old}} ( s , a )} \qquad ( equation 0.8 )$$

given the consistency condition. For example, given that the deployment environment is static, a computation cost associated with determining the policy gradient target may be reduced, such that the policy gradient target may be determined based on:

$${∇}_{θ} J = {\sum }_{t = 0}^{T} {∇}_{θ} {γ}^{t} log {π}_{θ} ( {a}_{t , i} \vert {s}_{t , i} ) \frac{{d}_{{MDP}_{new}} ( s , a )}{{d}_{{MDP}_{old}} ( s , a )} \hat{Q} ( {s}_{t , i} , {a}_{t , i} ) \qquad ( equation 1. )$$

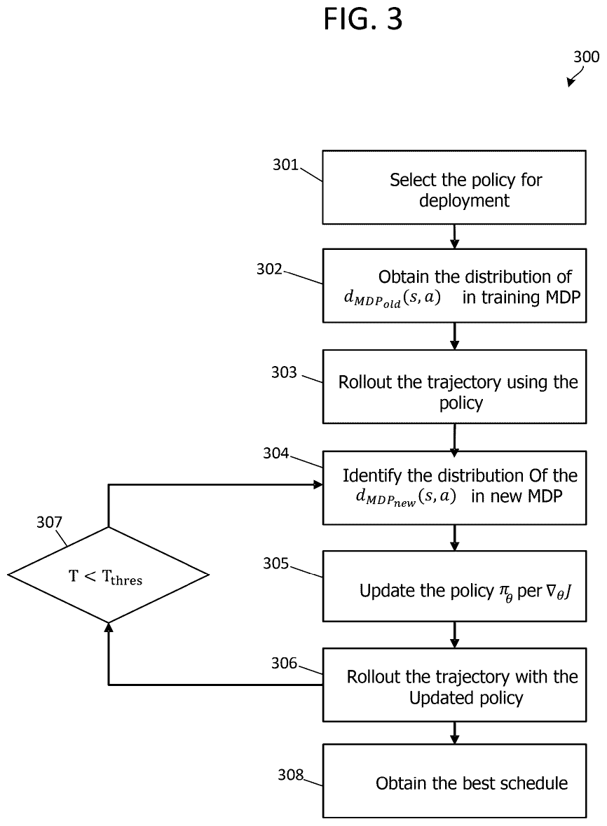

FIG. 3 is a flowchart depicting operations of a method for scheduling, according to some embodiments of the present disclosure.

Referring to FIG. 3, a method 300 for scheduling, as similarly discussed above with reference to FIG. 1B, may include one or more of the following operations. A processing circuit 120 (see FIGS. 1A-2) may select a first scheduling policy for deployment (operation 301). In some embodiments, the first scheduling policy may be trained in a training environment based on historic data. The processing circuit 120 may obtain the distribution (e.g., the steady-state distribution) associated with the training environment d_{MDP}_{_{old}}(s, a) (operation 302). The processing circuit 120 may rollout the trajectory using the first scheduling policy (operation 303). For example, the processing circuit 120 may execute the first scheduling policy in a deployment environment. The processing circuit 120 may identify the distribution of the first scheduling policy in the deployment environment d_{MDP}_{_{new}}(s, a) (operation 304). The processing circuit 120 may update the scheduling policy based on the policy gradient □_{θ}J, which, as discussed above, may be determined based on a ratio of the distribution of the first scheduling policy d_{MDP}_{_{new}}(s, a) in the deployment environment to the distribution of the first scheduling policy in the training environment d_{MDP}_{_{old}}(s, a) (operation 305). The processing circuit 120 may rollout the trajectory with the updated policy based on the policy gradient ∇_{θ}J (operation 306). For example, the processing circuit 120 may execute an updated scheduling policy in the deployment environment. The processing circuit 120 may determine whether a current time value T (e.g., an updated time value) is greater than or equal to a threshold time value Tₜₕᵣₑₛ (operation 307). If the current time value is greater than or equal to the threshold time value, the processing circuit 120 may obtain the best performing scheduling policy based on comparing performances of the scheduling policies (operation 308). If the current time value is less than the threshold time value, the processing circuit 120 may perform an iterative process of determining state distributions of new policies and determining corresponding policy gradients as in operations 304 through 306 until the current time value is greater than or equal to the threshold time value. Once the new scheduling policy (e.g., the best performing scheduling policy) is obtained, the processing circuit 120 may use the new scheduling policy to control a scheduling process of the system 1 (see FIG. 1).

In some embodiments, the new scheduling policy may be executed to coordinate machine actions in a factory, schedule navigation tasks, coordinate language model tasks, and/or the like. For example, executing the new scheduling policy, and controlling a scheduling process, may include changing the order of machine operations, selecting different navigation tasks, changing an order of language model tasks, and/or the like, based on the new scheduling-policy schedule.

The method 300 may be performed on one or more components of the electronic device 401 of FIG. 4. For example, one or more operations may be performed using a combination of software components and hardware components corresponding to the processor 420 and the memory 430 of FIG. 4.

FIG. 4 is a block diagram of an electronic device in a network environment 400, according to some embodiments of the present disclosure.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non- volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or the server 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

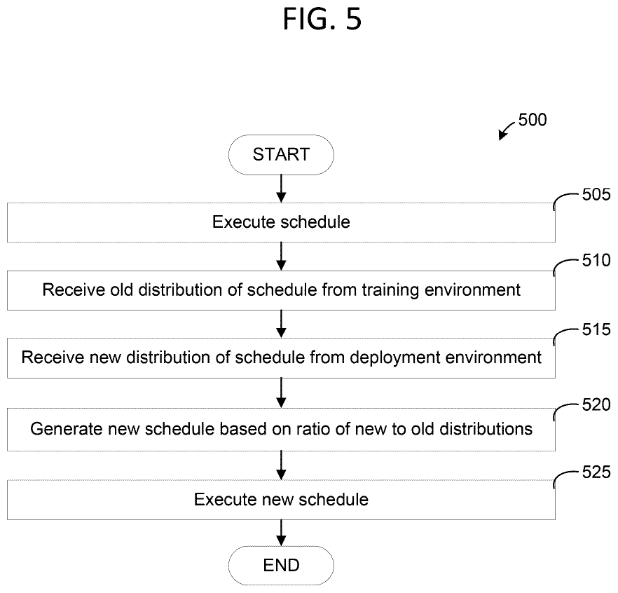

FIG. 5 is a flowchart of a method of executing a schedule (e.g., a scheduling policy), according to some embodiments of the present disclosure.

The method 500 shown in FIG. 5, may be performed, for example, by the processing circuit 120 described above with reference to FIGS. 1A-2. However, the present disclosure is not limited thereto, and the operations shown in the method 500 may be performed by any suitable one of the components and elements or any suitable combination of the components and elements of those of one or more embodiments described above. Further, the present disclosure is not limited to the sequence or number of the operations of the method 500 shown in FIG. 5, and can be altered into any desired sequence or number of operations as recognized by a person having ordinary skill in the art. For example, in some embodiments, the order may vary, or the method 500 may include fewer or additional operations. Further, the operations shown in method 500 may be performed sequentially, or at least some of the operations thereof may be performed concurrently (e.g., simultaneously, or substantially simultaneously).

Referring to FIG. 5, the method 500 may start, and a schedule (e.g., a scheduling policy) may be executed (operation 505). For example, in some embodiments, the schedule may be executed to coordinate machine actions in a simulation of a factory, schedule navigation tasks, coordinate language model tasks, and the like.

A policy state distribution of an environment used to train the scheduling policy associated with the schedule may be obtained (e.g., received) (operation 510). A policy state distribution of the environment associated with the simulation of the factory, navigation tasks, language model, and/or the like may be obtained (e.g., received) (operation 515). The schedule may be updated per the ratio of the state distributions (operation 520).

The new schedule may be executed (operation 525), and the method 500 may end. For example, executing the new schedule may include changing the order of machine operations, selecting different navigation tasks, changing an order of language model tasks, and the like, based on the new schedule.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for scheduling, the method comprising:
determining a second state distribution based on executing a first scheduling policy in a second environment,
generating a second scheduling policy based on a first policy gradient associated with a first state distribution and the second state distribution, the first state distribution being associated with the first scheduling policy and a first environment, different from the second environment; and
controlling a scheduling process based on the second scheduling policy.

2. The method of claim 1, further comprising determining the first state distribution based on executing the first scheduling policy in the first environment.

3. The method of claim 1, wherein the first environment comprises a training environment in which the first scheduling policy is trained.

4. The method of claim 3, wherein the first scheduling policy is trained based on historic data.

5. The method of claim 4, wherein:
the second environment comprises a deployment environment; and
the first scheduling policy is tested in the deployment environment based on present data that differs from the historic data based on at least one parameter.

6. The method of claim 1, further comprising:
determining a first performance associated with executing the first scheduling policy in the second environment; and
determining to perform the controlling of the scheduling process based on the second scheduling policy based on comparing a second performance, associated with executing the second scheduling policy in the second environment, with the first performance.

7. The method of claim 1, further comprising determining to perform the controlling of the scheduling process based on the second scheduling policy based on determining that a current time value is greater than or equal to a threshold time value.

8. The method of claim 1, further comprising, based on executing the first scheduling policy in the second environment, determining a trajectory associated with the first scheduling policy.

9. The method of claim 1, wherein the controlling the scheduling process based on the second scheduling policy comprises one of changing an order of machine operations, selecting different navigation tasks, or changing an order of language model tasks.

10. The method of claim 1, further comprising:
determining that a current time value is less than a threshold time value;
determining a third state distribution associated with the second scheduling policy; and
generating a third scheduling policy based on a second policy gradient associated with the second state distribution and the third state distribution.

11. A system for scheduling, the system comprising:
a processing circuit communicatively coupled to a machine, the processing circuit configured to perform:
determining a second state distribution based on executing a first scheduling policy in a second environment,
generating a second scheduling policy based on a first policy gradient associated with a first state distribution and the second state distribution, the first state distribution being associated with the first scheduling policy and a first environment, different from the second environment; and
controlling a scheduling process based on the second scheduling policy.

12. The system of claim 11, wherein the processing circuit is configured to perform determining the first state distribution based on executing the first scheduling policy in the first environment.

13. The system of claim 11, wherein the first environment comprises a training environment in which the first scheduling policy is trained.

14. The system of claim 13, wherein the first scheduling policy is trained based on historic data.

15. The system of claim 14, wherein:
the second environment comprises a deployment environment; and
the first scheduling policy is tested in the second environment based on updated data that differs from the historic data based on at least one parameter.

16. A system for scheduling, the system comprising:
a processing circuit and memory comprising instructions that, when executed by the processing circuit, cause the processing circuit to perform:
determining a second state distribution based on executing a first scheduling policy in a second environment,
generating a second scheduling policy based on a first policy gradient associated with a first state distribution and the second state distribution, the first state distribution being associated with the first scheduling policy and a first environment, different from the second environment; and
controlling a scheduling process based on the second scheduling policy.

17. The system of claim 16, wherein the instructions, when executed by the processing circuit, cause the processing circuit to perform determining the first state distribution based on executing the first scheduling policy in the first environment.

18. The system of claim 16, wherein the first environment comprises a training environment in which the first scheduling policy is trained.

19. The system of claim 18, wherein the first scheduling policy is trained based on historic data.

20. The system of claim 19, wherein:
the second environment comprises a deployment environment; and
the first scheduling policy is tested in the second environment based on updated data that differs from the historic data based on at least one parameter.
